(19) United States
(12) Patent Application Publication
(10) Pub. No.: US 2009/0301809 A1
(43) Pub. Date: Dec. 10, 2009

(54) Device for absorbing and reducing noise in the inside of a vehicle

(75) Inventors: Thomas Aurenz, Aidlingen (DE); Wolfgang Saeuberlich, Grafenau (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/919,339

(22) PCT Filed: Apr. 11, 2006
(86) PCT No.: PCT/EP2006/003305

§ 371 Date: Jul. 1, 2009

(30) Foreign Application Priority Data
Apr. 28, 2005 (DE) 10 2005 019 204.1

(51) Int. Cl. G10K 11/172; E04B 1/82

(52) U.S. Cl. 181/290; 181/284

(57) ABSTRACT

A device for absorbing and reducing low-frequency airborne sound in the inside of a vehicle. At locations at which disturbing low-frequency airborne sound occurs, at least one orifice at which low-frequency airborne sound waves are braked, is formed in an adjacent boundary edge surface (2) of the vehicle interior, such as, for example, the upper edge of the rear door. In order to prevent high-frequency airborne sound (for example, flow noises and/or other external noises) from penetrating into the vehicle interior, an absorber, which absorbs high-frequency airborne sound, is introduced into the boundary edge surface.

### BACKGROUND AND SUMMARY OF THE INVENTION

This application is a national stage of PCT International Application No. PCT/EP2006/003305, filed Apr. 11, 2006, which claims priority under 35 U.S.C. § 119 to German Patent Application No. 10 2005 019 204.1, filed Apr. 28, 2005, the disclosure of which is expressly incorporated by reference herein.

The invention relates to a device for absorbing and reducing noise in the interior of a vehicle.

It is known to use what are known as “sound absorbers” in order to damp loud noises which penetrate into the inside of the vehicle or are emitted into the surrounds (due for example, to the vehicle engine, tires, air flows and other noise-inducing assemblies). Such sound absorbers are arranged, in particular in the vehicle interior or passenger space, trunk space, engine space or the underfloor region, as disclosed, for example, in German patent document DE 199 10 274 A1. They have, for example, chamber-shaped inner spaces, so that the penetrating sound waves can be largely damped due to resonance effects. In addition to chamber absorbers, German patent document DE 92 00 501 U1 also discloses sound absorbers which consist of porous materials such as foams or nonwovens. Furthermore, German patent document DE 100 22 902 A1 shows what are known as film and membrane absorbers, in which a thin layer designed as a film is excited to oscillate by the sound waves, so that an energy loss of the sound wave thereby takes place, and it is damped.

German patent document DE 199 20 969 A1 discloses a build-in part for dividing off a high-noise inner-space part to form another space and/or for the cladding or covering components, which is itself designed as a sound absorber. The build-in part consists merely of a holed or perforated plate or a layer of between 0.1 and 50 mm, with a mean diameter or a mean width of the holes or perforations of between 0.001 and 2 mm and an area fraction of the holes or perforations in relation to the overall area of the build-in part of between 0.001 and 20%. The build-in part can be used, for example, as an inside roof lining, rear stowage shelf, door trim, solar protection or baggage space roller blind, as injection-molded cover units for a covering or cladding of cables and exhaust pipes, as underfloor trim or engine hood trim, as a heat protection shield of, in particular, sheet aluminum and as a wheel house shell.

Furthermore, German patent document DE 44 13 009 A1 discloses a motor vehicle sound absorber in the form of a double-walled flat resonance body with a front wall having numerous holes, and an essentially non-holed rear wall; that is, a combined plate/hole resonator. Sound absorption is performed by braking of air oscillation in the holes of the holed plate in interaction with the resonance space located behind the holes. Absorption in the range of lower frequencies (in particular of 250 Hz and below) occurs. With the parameters otherwise remaining the same, an enlargement of the volume of the cavity leads to a displacement of the absorption in the direction of lower frequencies. A reduction in the hole fraction acts in the same direction. Moreover, it is possible to provide sound damping mats in the inner space of the sound absorber, which effectively enhances the elimination of noise.

However, in all the above-described devices for absorbing noise in the inside of a vehicle, there is still a problem with unwanted noises, above all airborne sound in the low frequency range, in particular in the frequency range of about 25 to 50 Hz.

One object of the present invention, therefore, is to provide a device which reduces unwanted noises in the interior of a vehicle, (especially airborne sound in the low frequency range, particularly about 25 to 60 Hz), and absorbs high-frequency sound.

Another object of the invention is to provide such a device which can be produced simply and cost-effectively.

These and other objects and advantages are achieved by the sound absorption device according to the invention, in which low-frequency sound is absorbed through an orifice or orifices in the boundary edge surface in the passenger space, in conjunction with a resonance space located behind it, as a result of the braking of air oscillation. At the same time, sound-insulating material introduced into the resonance space prevents a penetration of high-frequency sound fractions into the inside of the vehicle from outside. Moreover, since, in the device according to the invention for absorbing noise in the inside of a vehicle, it is unnecessary to machine or configure complicated complete surfaces, production is markedly more cost-effective and less complicated.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a device according to the invention for absorbing and reducing noise, with orifices in the frame of the rear door;

FIG. 2 is a cross-sectional view of an embodiment of a device according to the invention for absorbing and reducing noise in a side door; and

FIG. 3 is a cross-sectional view of a further exemplary embodiment of a device according to the invention for absorbing and reducing noise in a side door.

### DETAILED DESCRIPTION OF THE DRAWINGS

A preferred embodiment of the present invention is explained in more detail below with reference to the drawings, in which identical elements are designated with the same reference symbols.

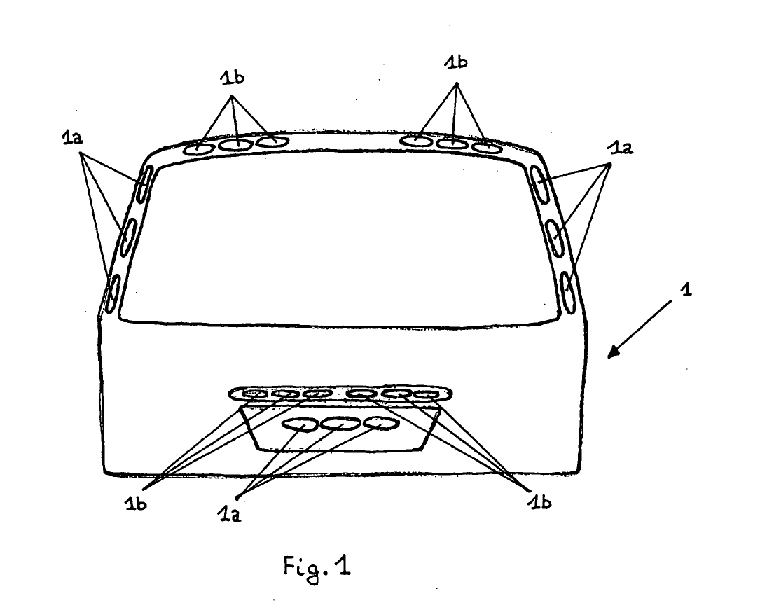

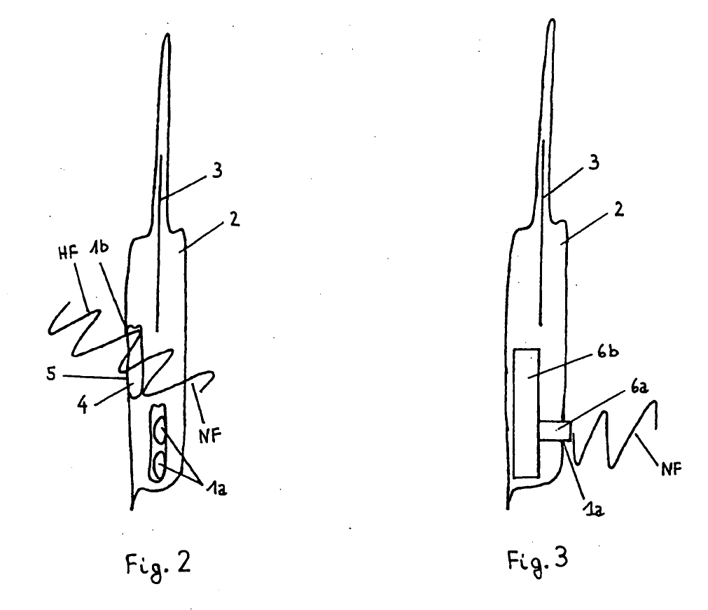

In the device according to the invention for absorbing and reducing noise in the inside of a vehicle, (shown in FIG. 1 by the example of a rear door 1) at least one orifice 1a or 1b, such as a slot or hole, is formed in an edge surface which bounds the vehicle interior. Such orifices may be formed, for example, in frame parts of the vehicle that face toward the interior side, so as to extend into a second sealing plane separated from the interior, or outwardly. So as not to allow high-frequency flow noises and external noises to enter again through the lock formed in this manner, a sound absorber 4, which acts as an absorber for high-frequency fractions HF, is introduced into the open boundary edge surface (for example, into the frame part), as shown in cross section in FIG. 2 in the example of a side door 2 with a side window 3. An absorber 4 of this type may consist, for example, of open-pore foam or nonwoven. To protect against dampness, the device may preferably be formed by a moisture lock 5, here a thin-walled membrane 5, such as, for example, an elastomeric membrane, plastic or metal sheets, on the perforations or orifices 1b; or in the form of an additional lock, such as is introduced in the interior ventilation present in any vehicle.

The preferred location for arranging the vehicle interior noise absorbing and reducing device according to the invention (in particular the at least one orifice 1a in the boundary edge surface with the vehicle interior) depends on the vehicle type and on the positions in its interior at which, above all, a disturbing low-frequency airborne sound level NF occurs. According to the invention, the at least one orifice la is formed only at or near the location at which this high, low-frequency sound level NF occurs, and not so as to cover a large area, as is customary in the prior art.

As noted previously, FIG. 1 shows a noise absorbing and reducing device according to the invention with orifices in the frame of the rear door 1. In this case, the at least one orifice 1a is formed in a boundary edge surface 2 in the interior of a vehicle with 3 rows of seats, in which a disturbing low-frequency airborne sound level NF occurs at ear level in the third row of seats. In particular, the at least one orifice la is formed in the boundary edge surface of the rear door 2 at its top edge. The frame of the rear door 2 thus forms a resonance space, at the entry region of which, (in particular, at the at least one orifice 1a) the disturbing low-frequency air oscillation NF can pass, braked through the low-frequency lock, in a similar way to an open tube. In addition, an absorber (not shown) which absorbs high-frequency airborne sound is introduced into the frame of the rear door 2. FIG. 1 shows, by way of example, positions for the at least one orifice, the orifices 1b being connections to the outside space and the orifices 1a being connections into a second sealing plane.

FIGS. 2 and 3 show cross-sectional views of two different exemplary embodiments of the invention, in a side door 2. In the case of a disturbing low-frequency airborne sound level NF in the first row of seats, one or more orifices 1a may be formed preferably in the side doors or in the A-column or in the foot space.

As shown in FIG. 2, an absorber 4 for high-frequency airborne sound HF is then likewise introduced into the resonance space, occurring due to the orifice or orifices 1a, in the side door 2.

For example, the loudspeaker membrane of the sound system, which is acoustically transparent for low-frequency airborne sound NF, may be used here as orifices 1a. In the resonance space formed in the side door 2 by means of the orifices 1a, the absorber 4 for high-frequency airborne sound HF is formed at at least one orifice 1b to the outside space and prevents external high-frequency airborne sound HF from entering the vehicle. A moisture lock 5 (here, a skin) formed in or above the at least one orifice 1b to the outside space, affords protection against moisture from the outside space.

It is of course possible to design a closed-off resonance space having only the at least one orifice 1a in the boundary edge surfaces of the vehicle interior, but it is also possible to open the resonance space directly towards the space outside the vehicle through the at least one orifice 1b. In the latter case, it is particularly important to introduce the absorber 4 for high-frequency airborne sound HF, since it is then necessary to avoid the penetration of high-frequency airborne sound HF (for example, air flow noises and other external noises) from the space outside the vehicle. Furthermore, then, because of the connection to the space outside the vehicle, a moisture lock 5 is also required, to avoid penetration of moisture into the vehicle interior. A metal or plastic membrane under a trim strip, planking or towards the A-column may be used as a lock 5 of this type.

As an alternative to the embodiment of FIG. 2, an embodiment, as shown in FIG. 3, is also possible, in which in contrast to FIG. 2 a Helmholtz resonator system replaces the orifices 1a and 1b and the absorber 4. The Helmholtz resonator system in this case consists of a Helmholtz resonator neck 6a, which is introduced into the side door 2 and forms a connection between the vehicle interior and a Helmholtz resonator volume 6b. The Helmholtz resonator system is tuned to the disturbing low-frequency airborne sound frequency which usually lies in the range of approximately 30 to 50 Hz. The Helmholtz resonator volume 6b in this case may be formed in boundary edge surfaces with the vehicle interior other than the side door 2, even by the cavity of a supporting member or from the A- or B-column.

Thus, an absorption of disturbing low-frequency airborne sound can be achieved in a simple, cost-effective way by means of the device according to the invention for absorbing and reducing noise in the inside of a vehicle, without a complicated configuration or design of special overall surface structures. The device for absorbing and reducing noise in the inside of a vehicle leads in this case to an agreeable inside noise level which, depending on the hole-arrangement/absorber tuning can be varied in terms of its acoustic pattern.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-13. (canceled)

14. Apparatus for absorbing and reducing noise in a vehicle interior, said apparatus comprising at least one orifice formed in an edge surface which bounds the vehicle interior, at a location proximate an area with a high low-frequency airborne sound level.

15. The apparatus as claimed in claim 14, wherein the at least one orifice is formed at a top edge of a rear door.

16. The apparatus as claimed in claim 14, wherein the at least one orifice is formed in one of a side door and an A-column of the vehicle.

17. The apparatus as claimed in claim 14, wherein the at least one orifice is formed in a foot space of the vehicle.

18. The apparatus as claimed in claim 14, wherein:
a resonance space is formed by the at least one orifice in said edge surface; and
an absorber for high-frequency airborne sound is provided in said resonance space.

19. The apparatus as claimed in claim 18, wherein the absorber consists of one of an open-pore foam and a nonwoven material.

20. The apparatus as claimed in claim 18, wherein:
the resonance space is open directly toward space external to the vehicle; and
at least one orifice between the resonance space and the space external to the vehicle has a thin-walled membrane on the at least one orifice or is designed in the form of an additional lock which prevents penetration of moisture into the vehicle interior.

21. The apparatus as claimed in claim 20, wherein the thin-walled membrane is formed from an elastomeric membrane, a plastic sheet, and a metal sheet.

22. The apparatus as claimed in claim 20, wherein the at least one orifice between the resonance space and space external to the vehicle is formed beneath a trim strip, a planking or toward the A-column.

23. The apparatus as claimed in claim 18, wherein an acoustic pattern of the inside noise level is established by means of the absorber/orifice tuning.

24. The apparatus as claimed in claim 14, wherein a Helmholtz resonator system, tuned to a low-frequency airborne sound is formed in the at least one orifice in a boundary edge surface with the vehicle interior.

25. The apparatus as claimed in claim 24, wherein the Helmholtz resonator system has a Helmholtz resonator neck which is introduced into the at least one orifice and which forms a connection between the vehicle interior and a Helmholtz resonator volume.

26. The apparatus as claimed in claim 24, wherein the Helmholtz resonator volume is formed by the cavity of a supporting member or from the A- or B-column.
